(19) United States
(12) Patent Application Publication
(10) Pub. No.: US 2016/0159077 A1
(43) Pub. Date: Jun. 9, 2016

(54) THERMAL ENERGY APPLIED TO DRIED PRINTING FLUID

(71) Applicant: HEWLETT-PACKARD DEVELOPMENT COMPANY, L.P., Houston, TX (US)

(72) Inventors: Jason Cassidy Hower, Corvallis, OR (US); James Kearns, Corvallis, OR (US); Gary Tarver, Corvallis, OR (US); Ali Emamjomeh, San Diego, CA (US); Jayanta C. Panditaratne, San Diego, CA (US); Christopher Arend Toles, Escondido, CA (US); Tao Chen, San Diego, CA (US)

(73) Assignee: HEWLETT-PACKARD DEVELOPMENT COMPANY, L.P., Houston, TX (US)

(21) Appl. No.: 14/907,495

(22) PCT Filed: Jul. 31, 2013
(86) PCT No.: PCT/US2013/052989

§ 371 Date: Jan. 25, 2016

(51) Int. Cl. B41F 23/04

(52) U.S. Cl. CPC B41F 23/04

(57) ABSTRACT

A printing system including a print engine, a drying module, and a heating module. The print engine applies printing fluid on media. The drying module dries the printing fluid and provides dried printing fluid. The heating module applies thermal energy to the dried printing fluid and transitions the dried printing fluid to a cured printing fluid that has improved durability versus the dried printing fluid.

### BACKGROUND

Printing presses reproduce text and images on a print medium. Typically, a printing press deposits ink on paper to reproduce the text and images. Often, printing is carried out in a large-scale industrial process for publishing and transaction printing. One type of printing press is a sheet fed printer. Another type of printing press is a web press.

A sheet fed printer prints on separate sheets of media, such as separate sheets of paper. A sheet fed printer can print on one side or both sides of the media.

web press prints on a continuous substrate or web of media, such as a roll of paper. A web press can print on one side or both sides of the web of media. Some web presses include a separate print engine for printing on each side of the web of media. In a web press, the web of media, such as paper from a roll of paper, flows through the web press on a series of rollers. One or more print engines deposit ink on the web of media.

After printing by a sheet fed printer or a web press, in post-processing, the media is processed into books, papers, pamphlets, magazines, or other suitable formats. Post-processing can include several connected machines for cutting, punching, folding, and stacking the processed media

### BRIEF DESCRIPTION OF THE DRAWINGS

FIG. 1 is a diagram illustrating one example of a printing system that improves the durability of printed text and images on media.

FIG. 2 is a diagram illustrating one example of a heating module that applies thermal energy to dried printing fluid on media.

FIG. 3 is a diagram illustrating one example of a web press system that prints on sides A and B of a web of media and improves the durability of the printed text and images on the web of media.

FIG. 4 is a diagram illustrating one example of a graph that indicates a change in color after rub testing versus temperature at the exit of a heating module.

FIG. 5 is a flow chart diagram illustrating one example of a method of printing that improves the durability of printed text and images on media.

FIG. 6 is a diagram illustrating one example of a method of printing that prints on sides A and B of media and improves the durability of the printed text and images on the media.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

The durability of the printed text and images on the media is important to print service providers, where the durability of the printed text and images refers to the resistance of the printed text and images to being rubbed off, scratched, scuffed, or otherwise degraded. This degradation can be due to handling of the media, which includes post-processing of the media and handling of the finished product. In post-processing, the media may be subjected to mechanical agitation of the media, such as by rollers and stacking mechanisms, shearing action, such as by cutting and punching mechanisms, and folding of the media. After post-processing, the finished product may be subjected to handling such as stacking, packaging, and shipping. Printed text and images that have increased durability are not degraded as much by the handling of the printed media as compared to other printed text and images that do not have increased durability. In one example, the durability of the printed text and images is referred to as the rub durability of the printed text and images.

The present description provides techniques for improving the durability of printed text and images on media through the addition of thermal energy to the printed text and images on the media. In one example, thermal energy is provided after the printing fluid, such as ink, has been applied and dried on the media. In one example, thermal energy increases the molecular mobility of the dried printing fluid and provides energy for chemical reactions and physical transformations of the dried printing fluid and between the dried printing fluid and the media. In one example, a heating module provides thermal energy to the dried printing fluid and the media to increase the temperature of the dried printing fluid to a critical temperature or transition temperature at which the dried printing fluid transitions to a cured printing fluid, which increases the durability of the printed images. In one example, a heating module provides thermal energy to dried ink on the media to transition the dried ink to a cured ink that has improved durability versus the dried ink.

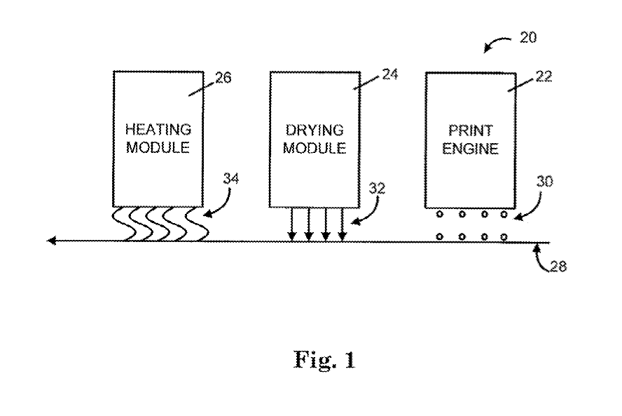

FIG. 1 is a diagram illustrating one example of a printing system 20 that improves the durability of printed text and images on media through the addition of thermal energy to the printed text and images on the media. System 20 includes a print engine 22, a drying module 24, and a heating module 26. Media 28 moves from right to left in FIG. 1, where it first passes print engine 22, then drying module 24, and then heating module 26. in one example, the media 28 is separate sheets of paper. In one example, the media 28 is paper from a roll of paper. In one example, the media 28 is a web of media that is over 40 inches wide.

Print engine 22 applies printing fluid 30, such as ink, onto the media 28 as the media 28 passes print engine 22. This creates text and images on the media 28. Print engine 22 can apply one or more colors of printing fluid 30 onto the media 28. In one example, print engine 22 applies up to four colors of ink and, optionally, a bonding agent onto the media 28. In one example, the printing fluid 30 is an aqueous based ink. In one example, the printing fluid 30 is an aqueous based ink that is not curable by electromagnetic waves, such as ultra-violet light waves. In one example, the printing fluid 30 is ink and print engine 28 includes thermal inkjet drop generators for applying the ink onto the media 28. In one example, the printing fluid 30 is ink and print engine 28 includes piezo-electric inkjet drop generators for applying the ink onto the media 28. In other examples, print engine 28 includes other suitable drop generators for applying ink onto the media 28.

Drying module 24 dries the printing fluid 30 on the media 28 as the media 28 passes by drying module 24. Drying module 24 blows heated air at 32 onto the printed text and images on the media 28. In one example, the printing fluid 30 is an aqueous based ink and drying module 28 blows heated air at 32 onto the ink and the media 28 to remove water from the ink. In one example, the printing fluid 30 is an aqueous based ink and drying module 28 blows heated air at 32 onto the ink and the media 28 to remove water from the ink, where the temperature of the heated air at 32 is less than the boiling point of water. In one example, drying module 24 includes heating elements and an air blower and exhaust system (not shown for clarity) for drying the printing fluid 30 on the media 28 as it passes by drying module 24.

Heating module 26 applies thermal energy at 34 to the dried printing fluid and the media 28. In one example, heating module 26 applies thermal energy to the dried printing fluid and the media 28 to transition the dried printing fluid to a cured printing fluid that has improved durability versus the dried printing fluid. In one example, the printing fluid 30 is ink and heating module 26 applies thermal energy to the dried ink on the media 28 to transition the dried ink to a cured ink that has improved durability versus the dried ink. In one example, the printing fluid 30 is an aqueous based ink and heating module 28 heats the dried aqueous based ink and the media 28 to a temperature that is greater than the boiling point of water.

The thermal energy at 34 from the heating module 26 increases the molecular mobility of the dried printing fluid and provides energy for chemical reactions and physical transformations of the dried printing fluid and between the dried printing fluid and the media 28. In one example, heating module 26 applies thermal energy at 34 to the dried printing fluid and the media 28 to increase the temperature of the dried printing fluid to a critical temperature or transition temperature at which the dried printing fluid transitions to the cured printing fluid, which increases the durability of the printed images. In one example, heating module 26 applies thermal energy at 34 to the dried printing fluid and the media 28 to increase the temperature of the dried printing fluid to a glass transition temperature. In one example, heating module 26 applies thermal energy at 34 to the dried printing fluid and the media to increase the temperature of the dried printing fluid to a cross-linking temperature. In one example, heating module 26 applies thermal energy at 34 to the dried printing fluid and the media to increase the temperature of the dried printing fluid to a diffusion temperature,

Heating module 26 is spaced apart from the media 28 and applies the thermal energy at 34 to the dried printing fluid on the media 28 from a distance. In one example, heating module 26 applies the thermal energy at 34 to the dried printing fluid and the media 28 via one or more of radiation, conduction, and convection. In one example, heating module includes a thermal energy unit and a sensor for sensing the temperature of the dried printing fluid and/or the media 28, where the thermal energy unit is spaced apart from (and does not touch) the dried printing fluid or the media and the thermal energy unit adjusts its thermal energy output based on data from the sensor.

Increasing the durability of the printed text and images on the media 28 allows the print service provider to run the printing system 20 at a faster media speed in feet per minute with a lower risk of damaged product. The increased durability of the printed text and images on the media 28 leads to less ink transfer, less scuffing, less buffing, less picking, and less tracking, which allows the print service provider to produce higher quality product at a faster rate.

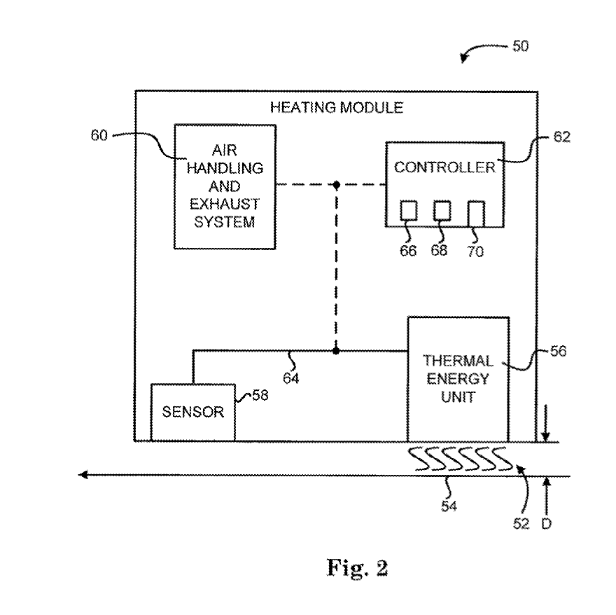

FIG. 2 is a diagram illustrating one example of a heating module 50 that applies thermal energy at 52 to dried printing fluid on media 54. Heating module 50 is spaced apart from the media 54 a distance D and applies the thermal energy at 52 to the dried printing fluid from distance D. In one example, heating module 50 is similar to heating module 26 (shown in FIG. 1) and the media 54 is similar to the media 28 (shown in FIG. 1).

Heating module 50 includes a thermal energy unit 56, a sensor 58, an air handling and exhaust system 60, and, optionally, a controller 62. Thermal energy unit 56 is communicatively coupled to sensor 58 via communications path 64. Optionally, thermal energy unit 56 and sensor 58 are communicatively coupled to air handling and exhaust system 60 and/or controller 62 via communications path 64.

Thermal energy unit 56 applies thermal energy at 52 to the dried printing fluid and the media 54. Thermal energy unit 56 applies thermal energy at 52 to increase the molecular mobility of the dried printing fluid and provide energy for chemical reactions and physical transformations of the dried printing fluid and between the dried printing fluid and the media 54. Thermal energy unit 56 is spaced apart from the media 54 distanced and applies thermal energy at 52 to the dried printing fluid from distance D. Thermal energy unit 56 applies thermal energy at 52 to the dried printing fluid and the media 54 via one or more of radiation, conduction, and convection.

Thermal energy unit 56 includes one or more devices for generating and applying the thermal energy at 52. In one example, thermal energy unit 56 includes resistive heating elements for generating and applying thermal energy at 52. In one example, thermal energy unit 56 includes infrared (IR) emitters for generating and applying thermal energy at 52. In one example, thermal energy unit 56 includes radio frequency (RF) emitters for generating and applying thermal energy at 52. In one example, thermal energy unit 56 includes microwave emitters for generating and applying thermal energy at 52.

Thermal energy unit 56 applies thermal energy at 52 to the dried printing fluid and the media 54 to transition the dried printing fluid to a cured printing fluid that has improved durability versus the dried printing fluid. Thermal energy unit 56 applies thermal energy at 52 to the dried printing fluid and the media 54 to increase the temperature of the dried printing fluid to a critical temperature or transition temperature at which the dried printing fluid transitions to the cured printing fluid, which increases the durability of the printed images. In one example, thermal energy unit 56 applies thermal energy at 52 to the dried printing fluid and the media 54 to increase the temperature of the dried printing fluid to a glass transition temperature. In one example, thermal energy unit 56 applies thermal energy at 52 to the dried printing fluid and the media 54 to increase the temperature of the dried printing fluid to a cross-linking temperature. In one example, thermal energy unit 56 applies thermal energy at 52 to the dried printing fluid and the media 54 to increase the temperature of the dried printing fluid to a diffusion temperature. In one example, the printing fluid is ink and thermal energy unit 56 applies thermal energy at 52 to the dried ink on the media 54 to transition the dried ink to a cured ink that has improved durability versus the dried ink. In one example, the printing fluid is an aqueous based ink and thermal energy unit 56 applies thermal energy at 52 to the dried aqueous based ink on the media 54 to a temperature that is greater than the boiling point of water.

Sensor 58 is a thermal sensor that senses the temperature of the cured printing fluid and/or the media 54. Sensor 58 provides sensor data that indicates the sensed temperature of the cured printing fluid and/or the media 54 via communications path 64. Sensor 58 is situated after thermal energy unit 56 in heating module 50, such that printed text and images on the media 54 move by thermal energy unit 56 prior to moving by sensor 58. In one example, thermal energy unit 56 is situated near the entrance of heating module 50, which accepts or receives the moving media 54, and sensor 58 is situated near the exit of heating module 50, which transmits the moving media 54. In one example, the speed of the media 54 is controlled via a web press system controller (not shown).

In operation, printed text and images on the media 54 move by thermal energy unit 56 and thermal energy unit 56 applies thermal energy to the dried printing fluid and the media 54 to cure the dried printing fluid. Next, the printed text and images on the media 54 move by sensor 58, which senses the temperature of the cured printing fluid and/or the media 54. Sensor 58 transmits the temperature data via communications path 64 and thermal energy unit 56 adjusts its thermal energy output level based on the temperature data provided by sensor 58. The application of thermal energy, sensing of temperature, and adjustment of thermal energy output is a dynamic process that takes place as the printing system continues to print user content text and images on the media 54. The printing system does not stop moving the media 54 through the printing system to adjust the thermal energy output of thermal energy unit 56. Instead, thermal energy unit 56 adjusts its thermal energy output level on the fly or as the system continues to print user content text and images on the media 54.

In one example, thermal energy unit 56 includes hardware and/or software for analyzing temperature data from sensor 58. This thermal energy unit 56 receives the temperature data directly from sensor 58 via communications path 64, analyzes the temperature data, and adjusts its thermal energy output level based on the data received from sensor 58. In one example, the thermal energy unit 56 that includes hardware and/or software for analyzing temperature data from sensor 58 adjusts its thermal energy output level to provide the critical temperature or transition temperature for transforming the dried printing fluid into the cured printing fluid. In one example, thermal energy unit 56 receives speed data on the movement of the media 54 from the web press system controller and thermal energy unit 56 adjusts its thermal energy output level based on the speed of the media 54. In one example, thermal energy unit 56 receives speed data on movement of the media 54 from the printing system controller and thermal energy unit 56 shuts down if movement of the media 54 has stopped or other conditions warrant shutting down.

Air handling and exhaust system 60 assists in transferring heat to the dried printing fluid and the media 54 and in controlling air exhaust from heating module 50. In one example, air handling and exhaust system 60 is controlled by a printing system controller (not shown). In one example, air handling and exhaust system 60 is communicatively coupled to thermal energy unit 56 via communications path 64 and thermal energy unit 56 controls air handling and exhaust system 60 via communications path 64.

Optionally, heating module 50 includes controller 62 that controls thermal energy unit 56 and, optionally, air handling and exhaust system 60. If included, controller 62 is communicatively coupled to thermal energy unit 56 and sensor 58 via communications path 64, and, optionally, controller 62 is communicatively coupled to air handling and exhaust system 60 via communications path 64. In another example, controller 62 is situated outside heating module 50. In other examples, controller 62 is part of the printing system controller.

in one example, controller 62 includes a processor 66, memory 68, also referred to as machine-readable (or computer-readable) storage media 68, and a network interface 70. The processor 66 is connected to network interface 70 to communicate over a network and the processor 66 is connected to memory 68. The processor 66 can include a microprocessor, a microcontroller, a processor module or subsystem, a programmable integrated circuit, a programmable gate array, and/or another control/computing device. The memory 68 can include different forms of memory including semiconductor memory devices, such as dynamic or static random access memories (DRAMs or SRAMs), erasable and programmable read-only memories (EPROMs), electrically erasable and programmable read-only memories (EEPROMs), and flash memories; magnetic disks such as fixed, floppy, and removable disks; other magnetic media including magnetic tape; optical media such as compact disks (CDs) and digital video disks (DVDs); and other types of storage devices. The techniques of the present disclosure can be implemented on a printing system, such as printing system 20 of FIG. 1, having machine-readable instructions stored in memory 68 and executed on processor 66. The machine-readable instructions can be provided on one computer-readable or machine-readable storage medium 68, or alternatively, can be provided on multiple computer-readable or machine-readable storage media 68 distributed in the printing system at multiple nodes. Such computer-readable or machine-readable storage media 68 is considered to be part of an article or article of manufacture, which can refer to any manufactured single component or multiple components. In one example, memory is located at a remote site from which machine-readable instructions can be downloaded over a network via network interface 70 for execution by processor 66.

Controller 62 includes hardware and software for analyzing temperature data from sensor 58 and providing a control signal to thermal energy unit 56 for adjusting the thermal energy output level from thermal energy unit 56. Controller 62 receives temperature data from sensor 58, analyzes the temperature data, and provides a control signal to thermal energy unit 56 to adjust the thermal energy output level of thermal energy unit 56 based on the data received from sensor 58. Optionally, controller 62 provides an air handling control signal to air handling and exhaust system 60 to adjust the temperature of the cured printing fluid and/or the media 58 sensed by sensor 58. In one example, controller 62 controls thermal energy unit 56 to adjust its thermal energy output level to provide the critical temperature or transition temperature for transforming the dried printing fluid into the cured printing fluid.

In operation, printed text and images on the media 54 move by thermal energy unit 56 and thermal energy unit 56 applies thermal energy to the dried printing fluid and the media 54 to cure the dried printing fluid. Next, the printed text and images on the media 54 move by sensor 58, which senses the temperature of the cured printing fluid and/or the media 54. Sensor 58 transmits temperature data via communications path 64 and controller 62 receives the temperature data from sensor 58, Controller 62 analyzes the temperature data and provides a thermal energy control signal based on the data received from sensor 58. Thermal energy unit 56 adjusts its thermal energy output level in response to the thermal energy control signal from controller 62. Optionally, controller 62 provides an air handling control signal to air handling and exhaust system 60 to at least assist in adjusting the temperature of the cured printing fluid and/or the media 58.

The application of thermal energy, sensing the temperature of the cured printing fluid and/or the media 54, analysis of the temperature data, providing a thermal energy control signal and, optionally, an air handling control signal, and adjusting the thermal energy output level of thermal energy unit 56 in response to the thermal energy control signal is a closed-loop system and a dynamic process that takes place as the printing system continues to print user content text and images on the media 54. The printing system does not stop moving the media 54 to adjust thermal energy output of thermal energy unit 56. Instead, thermal energy unit 56 adjusts its thermal energy output level on the fly or as the system continues to print user content text and images on the media 54. In one example, controller 62 receives speed data on movement of the media 54 and controller 82 provides the thermal energy control signal based on the speed data, such that thermal energy unit 56 adjusts its thermal energy output level based on the speed of the media 54. In one example, controller 62 receives speed data on movement of the media 54 and controller 62 shuts down thermal energy unit 56 if movement of the media 54 has stopped or other conditions warrant shutting down thermal energy unit.

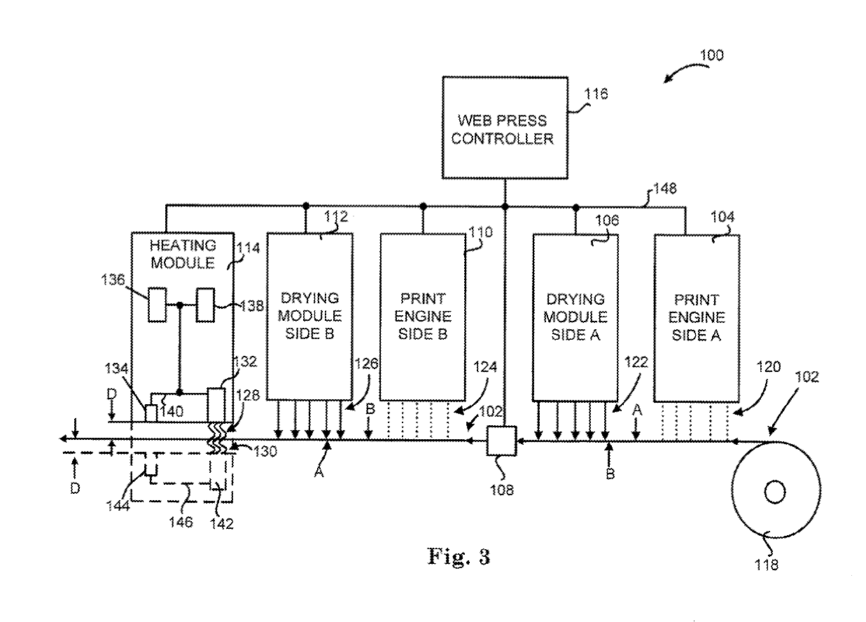

FIG. 3 is a diagram illustrating one example of a web press system 100 that improves the durability of printed text and images on sides A and B of a web of media 102 through the addition of thermal energy to the printed text and images on the web of media 102. System 100 includes a side A print engine 104, a side ,A drying module 106, a media turnover mechanism 108, a side B print engine 110, a side B drying module 112, a heating module 114, and a web press controller 116. in one example, side A print engine 104 and side B print engine 110 are each similar to print engine 22 (shown in FIG. 1). In one example, side A drying module 106 and side B drying module 112 are each similar to drying module 24 (shown in FIG. 1). In one example, heating module 114 is similar to heating module 26 (shown in FIG. 1). In one example, heating module 114 is similar to heating module 50 of FIG. 2.

The web of media 102 comes off a roll of media 118 and moves from right to left in FIG. 3, The web of media 102 comes off the roll of media 118 with side A up and side B down and passes side A print engine 104 and then side A drying module 106. The web of media 102 is turned over by media turn over mechanism 108 to have side B up and side A down and passes by side B print engine 110 and then side B drying module 112. Next, the web of media 102 passes by heating module 114 before proceeding to post-processing or being rolled onto a take-up roll (not shown). In one example, the web of media 102 is paper from a roll of paper 118. In one example, the web of media 102 is over 40 inches wide.

Side A print engine 104 applies printing fluid 120, such as ink, onto side A of the web of media 102 as the web of media 102 passes side A print engine 104. This creates text and images on side A of the web of media 102. Side A print engine 104 can apply one or more colors of printing fluid 120 onto side A of the web of media 102. In one example, side A print engine 104 applies up to four colors of ink and, optionally, a bonding agent onto side A of the web of media 102. In one example, the printing fluid 120 is an aqueous based ink. In one example, the printing fluid 120 is an aqueous based ink that is not curable by electromagnetic waves, such as ultra-violet light waves. In one example, the printing fluid 120 is ink and side A print engine 104 includes thermal inkjet drop generators for applying the ink onto side A of the web of media 102. In one example, the printing fluid 120 is ink and side A print engine 104 includes piezo-electric inkjet drop generators for applying the ink onto side A of the web of media 102. In other examples, side A print engine 104 includes other suitable drop generators for applying ink onto side A of the web of media 102.

Side A drying module 106 dries the printing fluid 120 on side A of the web of media 102 as the web of media 102 passes by side A drying module 106. Side A drying module 106 blows heated air at 122 onto the printed text and images on side A of the web of media 102. In one example, the printing fluid 120 is an aqueous based ink and side A drying module 106 blows heated air at 122 onto the ink and side A of the web of media 102 to remove water from the ink. In one example, the printing fluid 120 is an aqueous based ink and side A drying module 106 blows heated air at 122 onto the ink and side A of the web of media 102 to remove water from the ink, where the temperature of the heated air at 122 is less than the boiling point of water. In one example, side A drying module 106 includes heating elements and an air blower and exhaust system (not shown for clarity) for drying the printing fluid 120 on side A of the web of media 102.

Media turnover mechanism 108 turns the web of media 102 over such that side B is up and side A is down.

Side B print engine 110 applies printing fluid 124, such as ink, onto side B of the web of media 102 as the web of media 102 passes side B print engine 110. This creates text and images on side B of the web of media 102. Side B print engine 110 can apply one or more colors of printing fluid 124 onto side B of the web of media 102. In one example, side B print engine 110 applies up to four colors of ink and, optionally, a bonding agent onto side B of the web of media 102. In one example, the printing fluid 124 is an aqueous based ink. in one example, the printing fluid 124 is an aqueous based ink that is not curable by electromagnetic waves, such as ultra-violet light waves. In one example, the printing fluid 124 is ink and side B print engine 110 includes thermal inkjet drop generators for applying the ink onto side B of the web of media 102. In one example, the printing fluid 124 is ink and side B print engine 110 includes piezo-electric inkjet drop generators for applying the ink onto side B of the web of media 102. In other examples, side B print engine 110 includes other suitable drop generators for applying ink onto side B of the web of media 102.

Side B drying module 112 dries the printing fluid 124 on side B of the web of media 102 as the web of media 102 passes by side B drying module 112. Side B drying module 112 blows heated air at 126 onto the printed text and images on side B of the web of media 102. In one example, the printing fluid 124 is an aqueous based ink and side B drying module 112 blows heated air at 126 onto the ink and side B of the web of media 102 to remove water from the ink. In one example, the printing fluid 124 is an aqueous based ink and side B drying module 112 blows heated air at 126 onto the ink and side B of the web of media 102 to remove water from the ink, where the temperature of the heated air at 126 is less than the boiling point of water. In one example, side B drying module 112 includes heating elements and an air blower and exhaust system (not shown for clarity) for drying the printing fluid 124 on side B of the web of media 102.

Heating module 114 applies thermal energy at 128 to side B of the web of media 102 and, optionally, heating module 114 applies thermal energy at 130 to side A of the web of media 102. In one example, heating module 114 is similar to heating module 26 (shown in FIG. 1). In one example, heating module 114 is similar to heating module 50 of FIG. 2.

Heating module 114 includes a side B thermal energy unit 132, a side B sensor 134, an air handling and exhaust system 136, and a controller 138. Side B thermal energy unit 132 is communicatively coupled to side B sensor 134 via communications path 140. Also, side B thermal energy unit 132 and side B sensor 134 are communicatively coupled to air handling and exhaust system 136 and controller 138 via communications path 140.

Optionally, heating module 114 includes a side A thermal energy unit 142 and a side A sensor 144, where side A thermal energy unit 142 is communicatively coupled to side A sensor 144 via communications path 146. Also, side A thermal energy unit 142 and side A sensor 144 are communicatively coupled to air handling and exhaust system 136 and controller 138 via communications path 146 (not shown for clarity).

In one example, side B thermal energy unit 132 applies thermal energy at 128 to side B of the web of media 102 to cure the dried printing fluid on both side B and side A of the web of media 102. Side B thermal energy unit 132 applies thermal energy at 128 to increase the molecular mobility of the dried printing fluid and provide energy for chemical reactions and physical transformations of the dried printing fluid and between the dried printing fluid and the web of media 102. Side B thermal energy unit 132 is spaced apart from the web of media 102 a distance D and applies thermal energy at 128 to the web of media 102 from distance D. In one example, side B thermal energy unit 132 applies thermal energy at 128 to the web of media 102 via one or more of radiation, conduction, and convection.

In another example, side B thermal energy unit 132 applies thermal energy at 128 to side B of the web of media 102 to cure the dried printing fluid on side B of the web of media 102 and side A thermal energy unit 142 applies thermal energy at 130 to side A of the web of media 102 to cure the dried printing fluid on side A of the web of media 102. Each of the thermal energy units 132 and 142 applies thermal energy to increase the molecular mobility of the dried printing fluid and provide energy for chemical reactions and physical transformations of the dried printing fluid and between the dried printing fluid and the web of media 102. Also, each of the thermal energy units 132 and 142 is spaced apart from the web of media 102 distance D and applies thermal energy to the web of media 102 from distance D. In one example, each of the thermal energy units 132 and 142 applies thermal energy to the web of media 102 via one or more of radiation, conduction, and convection.

Each of the thermal energy units 132 and 142 includes one or more devices for generating and applying the thermal energy. In one example, one or both of the thermal energy units 132 and 142 includes resistive heating elements for generating and applying thermal energy. In one example, one or both of the thermal energy units 132 and 142 includes IR emitters for generating and applying thermal energy. In one example, one or both of the thermal energy units 132 and 142 includes RF emitters for generating and applying thermal energy. In one example, one or both of the thermal energy units 132 and 142 includes microwave emitters for generating and applying thermal energy.

In use, each of the thermal energy units 132 and 142 applies thermal energy to the web of media 102 to transition the dried printing fluid to a cured printing fluid that has improved durability versus the dried printing fluid. Also, each of the thermal energy units 132 and 142 applies thermal energy to the web of media 102 to increase the temperature of the dried printing fluid to a critical temperature or transition temperature at which the dried printing fluid transitions to the cured printing fluid, which increases the durability of the printed images. In one example, each of the thermal energy units 132 and 142 applies thermal energy to the web of media 102 to increase the temperature of the dried printing fluid to a glass transition temperature. In one example, each of the thermal energy units 132 and 142 applies thermal energy to the web of media 102 to increase the temperature of the dried printing fluid to a cross-linking temperature. In one example, each of the thermal energy units 132 and 142 applies thermal energy to the web of media 102 to increase the temperature of the dried printing fluid to a diffusion temperature. In one example, the printing fluid is ink and each of the thermal energy units 132 and 142 applies thermal energy to the web of media 102 to transition the dried ink to a cured ink that has improved durability versus the dried ink. In one example, the printing fluid is an aqueous based ink and each of the thermal energy units 132 and 142 applies thermal energy to the dried aqueous based ink on the web of media 102 to a temperature that is greater than the boiling point of water.

Sensor 134 is a thermal sensor that senses the temperature of the cured printing fluid and/or side B of the web of media 102. Sensor 134 provides sensor data that indicates the sensed temperature of the cured printing fluid and side B of the web of media 102 via communications path 140. Sensor 134 is situated after side B thermal energy unit 132 in heating module 114, such that printed text and images on the web of media 102 move by side B thermal energy unit 132 prior to moving by sensor 134. In one example, side B thermal energy unit 132 is situated near the entrance of heating module 114, which accepts or receives the moving web of media 102, and sensor 134 is situated near the exit of heating module 114, which transmits the moving web of media 102.

Optionally, sensor 144 is employed, where sensor 144 is a thermal sensor that senses the temperature of the cured printing fluid and side A of the web of media 102. Sensor 144 provides sensor data that indicates the sensed temperature of the cured printing fluid and side A of the web of media 102 via communications path 146. Sensor 144 is situated after side A thermal energy unit 142 in heating module 114, such that printed text and images on the web of media 102 move by side A thermal energy unit 142 prior to moving by sensor 144. In one example, side A thermal energy unit 142 is situated near the entrance of heating module 114, which accepts or receives the moving web of media 102, and sensor 144 is situated near the exit of heating module 114, which transmits the moving web of media 102.

Air handling and exhaust system 136 assists in transferring heat to the dried printing fluid and the web of media 102 and in controlling air exhaust from heating module 114. Air handling and exhaust system 136 is controlled by controller 138. In another example, air handling and exhaust system 136 is controlled by web press system controller 116. In another example, air handling and exhaust system 136 is controlled by one or both of the thermal energy units 132 and 142.

Controller 138 controls each of the thermal energy units 132 and 134 and the air handling and exhaust system 136. Controller 138 includes a processor, memory, and a network interface, similar to controller 62 (shown in FIG. 2), and controller 138 operates similar to controller 62. In another example, controller 138 is situated outside heating module 114.

Controller 138 includes hardware and software for analyzing temperature data from sensor 134 and providing a control signal to side B thermal energy unit 132 for adjusting the thermal energy output level of side B thermal energy unit 132. Controller 138 receives temperature data from sensor 134, analyzes the temperature data, and provides a control signal to side B thermal energy unit 132 to adjust the thermal energy output level of side B thermal energy unit 132 based on the data received from sensor 134. Also, controller 138 provides an air handling control signal to air handling and exhaust system 136 to adjust the temperature of the cured printing fluid and the web of media 102. In one example, controller 138 controls side B thermal energy unit 132 to adjust its thermal energy output level to provide the critical temperature or transition temperature for transforming the dried printing fluid into the cured printing fluid on both side A and side B of the web of media 102.

Optionally, controller 138 also includes hardware and software for analyzing temperature data from sensor 144 and providing a control signal to side A thermal energy unit 142 for adjusting the thermal energy output level of side A thermal energy unit 142. Controller 138 receives temperature data from sensor 144, analyzes the temperature data, and provides a control signal to side A thermal energy unit 142 to adjust the thermal energy output level of side A thermal energy unit 142 based on the data received from sensor 144. In one example, controller 138 controls side A thermal energy unit 142 to adjust its thermal energy output level to provide the critical temperature or transition temperature for transforming the dried printing fluid into the cured printing fluid.

Web press system controller 116 controls web press system 100. Web press system controller 116 is communicatively coupled to side A print engine 104, side A drying module 106, media turnover mechanism 108, side B print engine 110, side B drying module 112, and heating module 114 via communications path 148. In one example, the speed of the web of media 102 is controlled via web press system controller 118. In one example, web press system controller 116 includes a processor, memory, and a network interface, similar to controller 62 (shown in FIG. 2). In one example, web press system controller 116 operates similar to controller 62.

In operation of web press system 100 and a heating module 114 that includes the optional side A thermal energy unit 142 and side A sensor 144, the web of media 102 rolls off the roll of media 118 and moves from right to left in FIG. 3. The web of media 102 comes off the roll of media 118 with side A up and side B down and passes side A print engine 104 and then side A drying module 106.

Side A print engine 104 applies printing fluid 120, such as ink, onto side A of the web of media 102 as the web of media 102 passes side A print engine 104 to create text and images on side A of the web of media 102. Side A drying module 106 dries the printing fluid 120 on side A of the web of media 102 as the web of media 102 passes by side A drying module 106. Side A drying module 106 blows heated air at 122 onto the printed text and images on side A of the web of media 102 to dry the printing fluid 120.

The web of media 102 is turned over by media turn over mechanism 108 to have side B up and side A down and next passes by side B print engine 110 and then side B drying module 112. Side B print engine 110 applies printing fluid 124, such as ink, onto side B of the web of media 102 as the web of media 102 passes side B print engine 110 to create text and images on side B of the web of media 102, Side B drying module 112 dries the printing fluid 124 on side B of the web of media 102 as the web of media 102 passes by side B drying module 112. Side B drying module 112 blows heated air at 126 onto the printed text and images on side B of the web of media 102 to dry the printing fluid 124.

Next, the web of media 102 passes by heating module 114 before proceeding to post-processing or being rolled onto a take-up roll (not shown). Heating module 114 applies thermal energy at 128 to side B of the web of media 102 and heating module 114 applies thermal energy at 130 to side A of the web of media 102. Side B thermal energy unit 132 applies thermal energy at 128 to side B of the web of media 102 to cure the dried printing fluid on side B of the web of media 102 and side A thermal energy unit 142 applies thermal energy at 130 to side A of the web of media 102 to cure the dried printing fluid on side A of the web of media 102. Each of the thermal energy units 132 and 142 applies thermal energy to increase the molecular mobility of the dried printing fluid and provide energy for chemical reactions and physical transformations of the dried printing fluid and between the dried printing fluid and the web of media 102.

Next, the web of media 102 moves by sensors 134 and 144, which sense the temperature of the cured printing fluid and/or the web of media 102 on sides B and A of the web of media 102, respectively. Each of the sensors 134 and 144 transmits temperature data that is received by controller 138. Controller 138 analyzes the temperature data and provides a side B thermal energy control signal to side B thermal energy unit 132 and a side A thermal energy control signal to side A thermal energy unit 142 based on the data received from sensors 134 and 144. Each of the thermal energy units 132 and 142 adjusts their thermal energy output level in response to the thermal energy control signals from controller 138. Also, controller 138 provides an air handling control signal to air handling and exhaust system 136 to at least assist in adjusting the temperature of the cured printing fluid and/or the web of media 102.

In one example, controller 138 receives speed data on movement of the web of media 102 and controller 138 provides the thermal energy control signals based on the speed data, such that each of the thermal energy units 132 and 142 adjusts its thermal energy output level based on the speed of the web of media 102. In one example, controller 138 receives speed data on movement of the web of media 102 and controller 138 shuts down the thermal energy units 132 and 142 if movement of the web of media 102 has stopped or other conditions warrant shutting down the thermal energy units.

The application of thermal energy, sensing the temperature of the cured printing fluid and/or the web of media 102, analysis of the temperature data and providing of thermal energy control signals and an air handling control signal, and the adjustment of thermal energy output by each of the thermal energy units 132 and 142 in response to the thermal energy control signals constitutes a closed-loop system in a dynamic process that takes place as web press system 100 prints user content text and images on the web of media 102. The web print system 100 does not stop moving the web of media 102 to adjust thermal energy output levels of the thermal energy units 132 and 142. Instead, each of the thermal energy units 132 and 142 adjusts its thermal energy output level on the fly or as the web press system 100 continues to print user content text and images on the web of media 102.

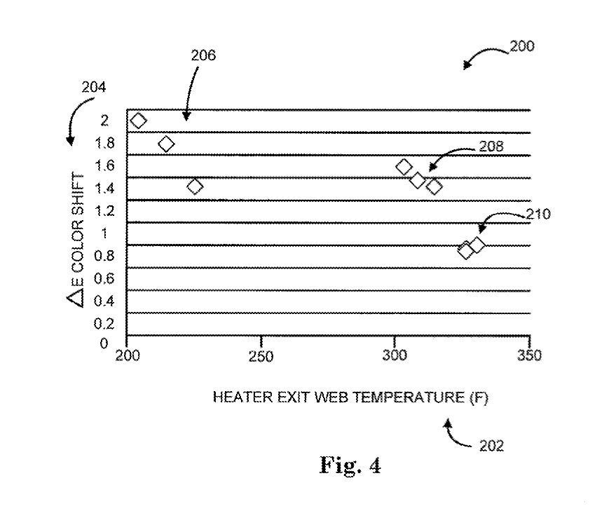

FIG. 4 is a diagram illustrating one example of a graph 200 that indicates the change in color in text and images on media after rub testing versus the temperature of the printing fluid and the media at the exit of the heating module. The temperature of the printing fluid and the media is graphed along the x-axis at 202 in degrees Fahrenheit and the delta E color shift in text and images on the media is graphed along the y-axis at 204.

Delta E is the difference in color between two shades of color, including the chrome, saturation, and darkness of the two shades of color. Higher delta E color shifts represent greater differences in color.

At 206 a group of three samples were heated to between 200 and 225 degrees Fahrenheit at the exit of the heating module. Each of the samples was rub tested and the delta E color shift determined for each sample after rub testing. The delta E color shift for the group of three samples at 206 was between 1.3 and 1.9.

At 208 a group of three samples were heated to between 300 and 325 degrees Fahrenheit at the exit of the heating module. Each of the samples was rub tested as before and the delta E color shift determined for each sample after rub testing. The delta E color shift for the group of three samples at 208 was between 1.3 and 1.5.

At 210 a group of three samples were heated to greater than 325 degrees Fahrenheit at the exit of the heating module. Each of the samples was rub tested as before and the delta E color shift determined for each sample after rub testing. The delta E color shift for the group of three samples at 210 was about 0.8, which is significantly better than the delta E color shift in the group at 206 and the group at 208.

This improvement in the delta E role r shift or group 210 is attributable to the temperature at the exit of the heating module. The printing fluid and the media were heated above the critical temperature or transition temperature for the printing fluid, of greater than 325 degrees Fahrenheit in this example, and the durability of the cured printing fluid increased as indicated by the decrease in the delta E color shift for the group of three samples at 210.

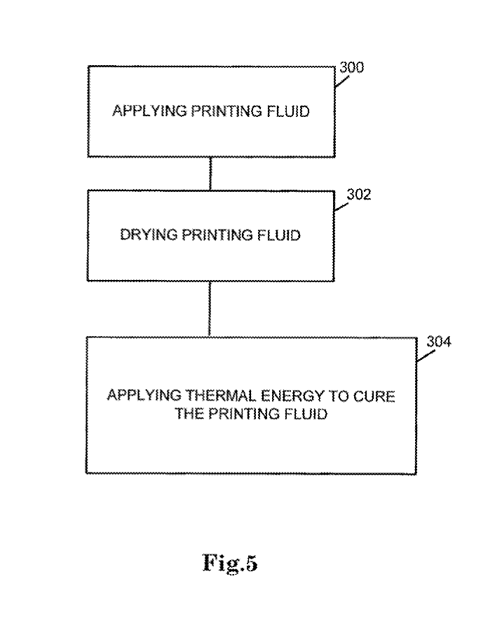

FIG. 5 is a flow chart diagram illustrating one example of a method or process of printing that improves the durability of printed text and images on media through the addition of thermal energy to the printed text and images on the media.

Media such as media 28 (shown in FIG. 1) passes a print engine such as print engine 22, a drying module such as drying module 24, and a heating module such as heating module 26. At 300, the print engine applies printing fluid, such as ink, onto the media as it passes the print engine. This creates text and images on the media.

At 302, the drying module dries the printing fluid on the media as the media passes by the drying module. The drying module blows heated air onto the printed text and images on the media.

At 304, the heating module applies thermal energy to the dried printing fluid and the media. The heating module applies thermal energy to the dried printing fluid and the media to transition the dried printing fluid to a cured printing fluid that has improved durability versus the dried printing fluid. The thermal energy increases the molecular mobility of the dried printing fluid and provides energy for chemical reactions and physical transformations of the dried printing fluid and between the dried printing fluid and the media. The heating module is spaced apart from the media and applies the thermal energy to the dried printing fluid on the media from a distance.

In one example, the printing fluid is ink and the heating module applies thermal energy to the dried ink on the media to transition the dried ink to a cured ink that has improved durability versus the dried ink. In one example, the printing fluid is an aqueous based ink and the heating module heats the dried aqueous based ink and the media to a temperature that is greater than the boiling point of water.

In one example, the heating module applies thermal energy to the dried printing fluid and the media to increase the temperature of the dried printing fluid to a critical temperature or transition temperature at which the dried printing fluid transitions to the cured printing fluid, which increases the durability of the printed images. In one example, the heating module applies thermal energy to the dried printing fluid and the media to increase the temperature of the dried printing fluid to a glass transition temperature. In one example, the heating module applies thermal energy to the dried printing fluid and the media to increase the temperature of the dried printing fluid to a cross-linking temperature. in one example, the heating module applies thermal energy to dried printing fluid and the media to increase the temperature of the dried printing fluid to a diffusion temperature.

Increasing the durability of the printed text and images on the media allows the print service provider to run the printing system at a faster media speed in feet per minute with a lower risk of damaged product. The increased durability of the printed text and images on the media leads to less ink transfer, less scuffing, less buffing, less picking, and less tracking, which allows the print service provider to produce higher quality product at a faster rate.

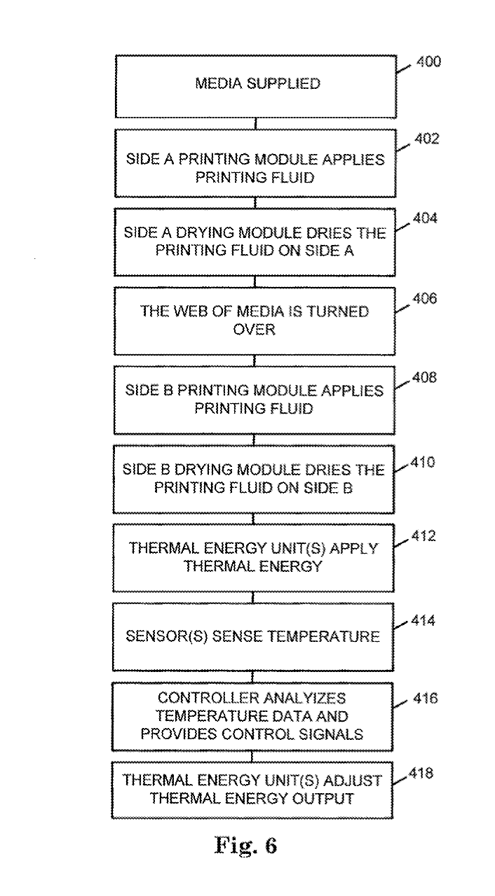

FIG. 6 is a diagram illustrating one example of a method of web press printing. At 400, media is supplied to the printing press with side A up and side B down. In one example, the media is sheets of paper. In one example, the media comes off a roll of media having side A up and side B down. At 402, a side A print engine applies printing fluid, such as ink, onto side A of the media to create text and images on side A of the media. Next, at 404, a side A drying module dries the printing fluid on side A of the media.

The media is turned over by a turn over mechanism, at 406, to have side B up and side A down. At 408, a side B print engine applies printing fluid, such as ink, onto side B of the media to create text and images on side B of the media and, at 410, a side B drying module dries the printing fluid on side B of the media.

The media then passes by a heating module before proceeding to post-processing or being rolled onto a take-up roll. At 412, one or more thermal energy units apply thermal energy to side A and side B of the media. The thermal energy unit(s) apply thermal energy to the media to cure the dried printing fluid on side A and side B of the media. The thermal energy unit(s) apply thermal energy to increase the molecular mobility of the dried printing fluid and provide energy for chemical reactions and physical transformations of the dried printing fluid and between the dried printing fluid and the media. Next, at 414, the media moves by one or more sensors, which sense the temperature of the cured printing fluid and/or the media. The sensor(s) transmit temperature data that is received by a controller.

At 416, the controller analyzes the temperature data and provides one or more thermal energy control signals to the thermal energy unit(s) based on the data received from the sensor(s). At 418, the thermal energy unit(s) adjust their thermal energy output levels in response to the thermal energy control signal(s) from the controller. Also, the controller provides an air handling control signal to an air handling and exhaust system to at least assist in adjusting the temperature of the printing fluid and/or the media. In one example, the controller receives speed data on movement of the media and the controller provides the thermal energy control signal(s) based on the speed data, such that the thermal energy unit(s) adjusts its thermal energy output level based on the speed of the media In one example, the controller receives speed data on movement of the media and the controller shuts down the thermal energy unit(s) if movement of the media has stopped or other conditions warrant shutting down the thermal energy unit(s).

The application of thermal energy, sensing the temperature of the printing fluid and/or the media, analysis of temperature data and providing one or more thermal energy control signals and an air handling control signal, and the adjustment of thermal energy output by the one or more thermal energy units constitutes a dynamic process that takes place as the printing system continues to print user content text and images on the media.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A printing system comprising:
a print engine to apply printing fluid on media;
a drying module to dry the printing fluid and provide dried printing fluid; and
a heating module to apply thermal energy to the dried printing fluid and transition the dried printing fluid to a cured printing fluid that has improved durability versus the dried printing fluid.

2. The printing system of claim 1, wherein the heating module comprises:
a thermal energy unit to apply the thermal energy to the dried printing fluid; and
a sensor to sense a temperature of the media, wherein the thermal energy unit adjusts thermal energy output of the thermal energy unit based on data from the sensor as the printing system continues to print on the media.

3. The printing system of claim 2, wherein the heating module comprises:
a controller to receive data from the sensor and provide a control signal to the thermal energy unit to adjust the thermal energy output of the thermal energy unit.

4. The printing system of claim 2, wherein the heating module comprises:
an air handling system to regulate heat transfer to the media and air exhaust from the heating module.

5. The printing system of claim 1, wherein the printing fluid is an aqueous based ink and the heating module heats the dried printing fluid to a temperature that exceeds the boiling point of water.

6. The printing system of claim 1, wherein the heating module provides the thermal energy via at least one of infrared emitters, radio frequency emitters, microwave emitters, and resistive heating elements.

7. A printing system comprising:
a first print engine to apply first printing fluid on a first side of media;
a first drying module to dry the first printing fluid and provide first dried printing fluid on the first side of the media; and
a heating module that includes a thermal energy unit spaced apart from the media to apply thermal energy to the first dried printing fluid on the first side of the media.

8. The printing system of claim 7, comprising;
a second print engine to apply second printing fluid on a second side of the media;
a second drying module to dry the second printing fluid and provide second dried printing fluid on the second side of the media, wherein the heating module is to apply thermal energy to the first dried printing fluid and the second dried printing fluid.

9. The printing system of claim 7, wherein the thermal energy unit provides the thermal energy to the media via one of radiation, conduction, and convection.

10. The printing system of claim 7, wherein the thermal energy unit heats the first dried printing fluid to a critical temperature that transitions the first dried printing fluid to a cured printing fluid that has improved durability versus the first dried printing fluid.

11. A method of printing comprising:
applying printing fluid on media;
drying the printing fluid to provide dried printing fluid; and
applying thermal energy to the dried printing fluid to transition the dried printing fluid to a cured printing fluid that has improved durability versus the dried printing fluid.

12. The method of claim 11, comprising:
sensing a temperature of the media; and
adjusting an amount of thermal energy output based on data from the sensor.

13. The method of claim 12, comprising:
receiving data from the sensor at a controller; and
providing a control signal from the controller to adjust the amount of the thermal energy output based on the data from the sensor.

14. The method of claim 12, comprising:
regulating heat transfer to the media and air exhaust away from the media.

15. The method of claim 11, wherein applying thermal energy to the dried printing fluid comprises:
applying the thermal energy via a thermal energy unit that is spaced apart from the media.
